(19) United States
(12) Patent Application Publication
(10) Pub. No.: US 2011/0305827 A1
(43) Pub. Date: Dec. 15, 2011

(54) Methods of Using a Non-Photocatalytic Porous Coating as an Antisoiling Coating

(75) Inventors: Jean-Pierre Boilot, Meudon (FR); Mamonjy Cadet, Charenton Le Pont (FR); Thierry Gacoin, Bures-Sur-Yvette (FR); Muriel Matheron, Chambery (FR); Lorraine Raboin, Los Angeles, CA (US); Laurianne Vagharchakian, Paris (FR)

(73) Assignee: Essilor International (Compagnie Generale d'Optique), Charenton Le Pont (FR)

(21) Appl. No.: 13/002,299

(22) PCT Filed: Jul. 1, 2009
(86) PCT No.: PCT/FR2009/051278

§ 371 Date: Aug. 31, 2011

(30) Foreign Application Priority Data
Jul. 1, 2008 (FR) 0854453

(51) Int. Cl. C08J 9/28; B05D 5/06; B05D 3/10; C09K 3/00; C08G 77/06

(52) U.S. Cl. 427/165; 521/154; 427/164; 521/63

(57) ABSTRACT

The present invention relates to the use as an antisoiling coating of a porous coating comprising a polysiloxane matrix and a porous volume such that the potential filling ratio of the total volume of said coating by oleic acid is at least 25% by volume, having a porosity rate ranging from 25 to 70% by volume and having no photocatalytic properties. The antisoiling porous coating is self-cleaning, easy to clean and can be regenerated by simple washing. It is mainly intended for use in ophthalmic optics, and proves to be very effective against sebum. In the preferred embodiment of the invention, this coating has a mesoporous structure.

The present invention generally relates to the use as antisoiling coatings of porous sol-gel coatings (or films) having a polysiloxane matrix, preferably a silica-based matrix, with no photocatalytic properties. They are mainly intended to be incorporated into substrates made from mineral or organic glass, especially in ophthalmic optics.

Increasingly, the trend is seeking to functionalize articles made from mineral or organic glass by depositing onto the surface thereof coatings that are a few nanometers or micrometers thick in order to impart the same a given property depending on the intended use. Thus, anti-reflection, abrasion-resistant, scratch-resistant, impact-resistant, anti-fogging or antistatic layers can be provided.

The presence of water and/or soil leads to an unaesthetic appearance, a vision impairment through these articles and to a decrease in the transparency of the articles, which is particularly cumbersome when those glasses are to be used for driving a car or to correct an ophthalmic defect.

To remedy such drawbacks, it is known to coat these articles with an antisoiling outer coating which reduces the surface energy so as to prevent polar or non polar compounds from adhering to the articles and from forming a detrimental film.

In ophthalmic optics, lenses of the last generation most of the time comprise a hydrophobic and/or oleophobic antisoiling coating, based on fluorinated materials such as fluorinated organosilanes or organosilazanes. These are coatings which static contact angle with deionized water is higher than or equal to 90°, or even higher than or equal to 100° for the best ones. Such coatings are described for example in the patents and applications U.S. Pat. No. 6,277,485, U.S. Pat. No. 6,183,872, EP 452723, EP 492545, EP 1300433 and JP 2005-187936.

The international application WO 2003/087002 describes a substrate provided with a mesoporous antisoiling (self-cleaning) coating, comprising a silica-based matrix containing nanoparticles or elementary crystallites of at least partially crystallized titanium dioxide. These coatings, also described in the applications WO 97/10185, WO 97/10186, WO 99/44954 and WO 01/66271 possess photocatalytic properties, from which are derived their self-cleaning properties. They are able, under the action of a radiation with a suitably chosen wavelength (typically ultraviolet, possibly in the visible range), to initiate radical reactions that result in the organic soil oxidation.

However, the activity of these coatings is dictated by their exposure level, for a sufficient period of time, to an intense enough radiation having a suitably chosen wavelength, together with water for draining the degradation residues. The typically slow degradation kinetics of organic soils thus occurs in a more efficient way under favorable environmental climatic conditions.

The application FR 2 787 350 describes a substrate comprising a mesoporous film which surface has been functionalized by grafting molecules, especially hydrophobic and/or oleophobic molecules, so as to provide the same with antisoiling properties. Such coating is prepared in two steps. After the step of forming the mesoporous film, which is typically a film having a polysiloxane matrix, grafting of the hydrophobic and/or oleophobic molecules is carried out using the liquid or gas procedure, starting from fluorinated silanes or from silanes bearing hydrophobic alkyl groups.

There is thus a need for glasses getting less soiled whatever the climatic conditions, which would enable especially to reduce the cleaning frequency needed, to improve vision therethrough and/or to facilitate the ease of cleaning the same. These glasses would be able to absorb and/or to remove soils gradually depositing onto the surface thereof.

Until now, the effect of porous material porosity, in particular of mesoporous material porosity, on their antisoiling properties, independently from the influence of photocatalytic metallic oxides, has not been yet evaluated.

The international application WO 2006/021698 describes mesoporous layers with a silica-based matrix and a porosity of about 55%. These low refractive index layers are used as outer layers of an anti-reflection coating. In one embodiment, the mesoporous layer is covered with an additional antisoiling coating having a low thickness (typically <10 nm), that is fluorosilicone or fluorosilazane in nature.

Now, the applicant has discovered that some porous coatings having a polysiloxane matrix, and more particularly based on silica which pores have not been filled with organic or inorganic, photocatalytic molecules or particles possess antisoiling properties, especially anti-sebum properties, so that they can be used as outer layers for optical stacks with no need to cover the same with any additional antisoiling coating.

High-performance antisoiling coatings have thus been developed, especially thanks to the porosity optimization and, to a lesser extent, to the beneficial reactivity of the matrix silanol functions, said functions being able to catalyze the hydrolysis of some organic compounds.

The present invention relates to the use as antisoiling coating of a porous coating having no photocatalytic properties, comprising a polysiloxane matrix, preferably based on silica, having a porosity rate ranging from 25 to 70% by volume and a volume such that the potential filling ratio of said porous coating volume by oleic acid is at least 25% by volume.

The invention will be described in more details by referring to the appended Figures, wherein:

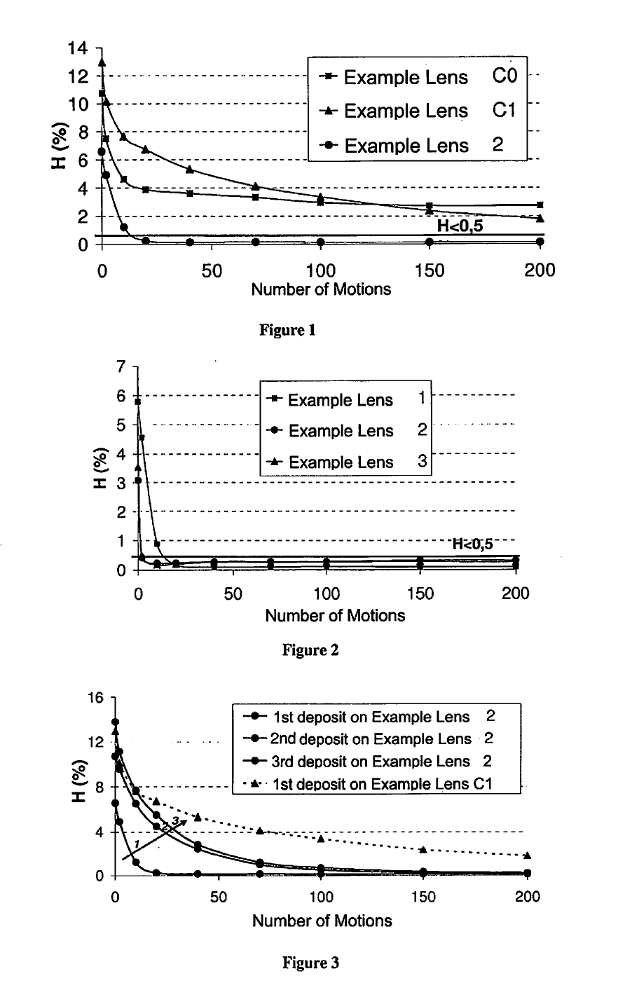

FIGS. 1, 2, 10 and 12 show the evolution of the diffusion rate in transmission as a function of the number of wiping motions effected on lenses provided with a coating according to the invention and on comparative lenses, that have been soiled through a soil deposition, and make it possible to assess their improved cleanability.

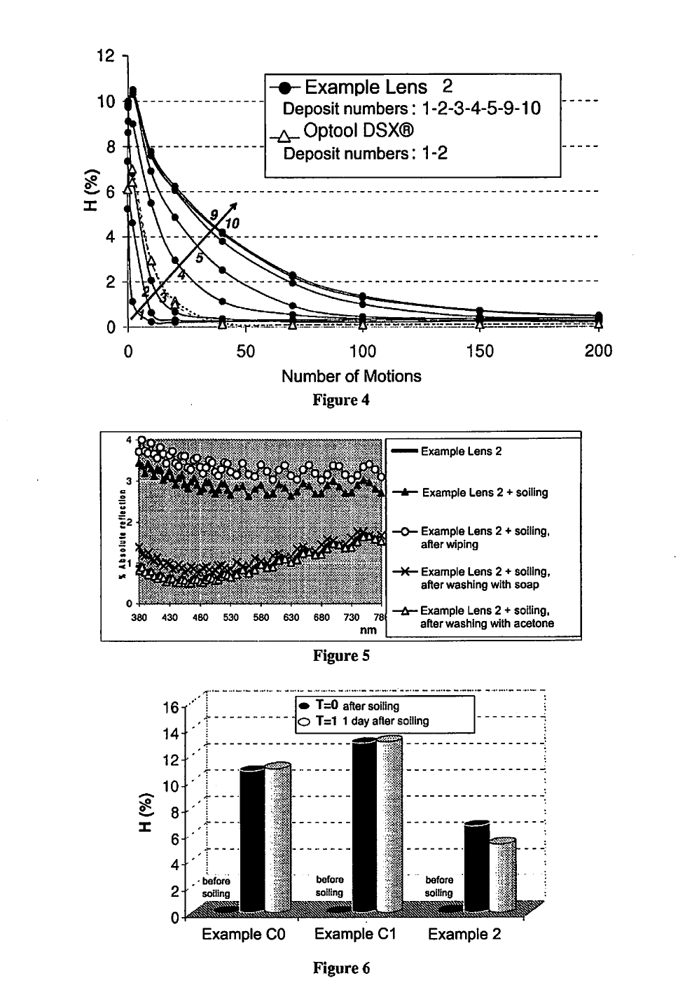

FIGS. 3 and 4 show the evolution of the diffusion rate in transmission as a function of the number of wiping motions effected on lenses provided with a coating according to the invention and on comparative lenses that have been soiled through several successive soil depositions, and make it possible to assess their improved cleanability.

FIG. 5 shows the evolution of the reflection as a function of wavelength at the surface of lenses provided with a coating according to the invention that have been soiled, or not, through a soil deposition, and that have optionally been submitted to wiping or to a regenerating treatment.

FIGS. 6, 7, 11 and 13 show the evolution of the diffusion rate in transmission as a function of time for lenses provided with a coating according to the invention and comparative lenses, making it thus possible to assess their self-cleaning properties.

FIG. 8 shows several pictures from a microscope of the surface state of lenses provided with a coating according to the invention and of comparative lenses, that have been soiled through a soil deposition, which reveal, for coatings according to the invention, the presence of a diffusion front of the soil's liquid part.

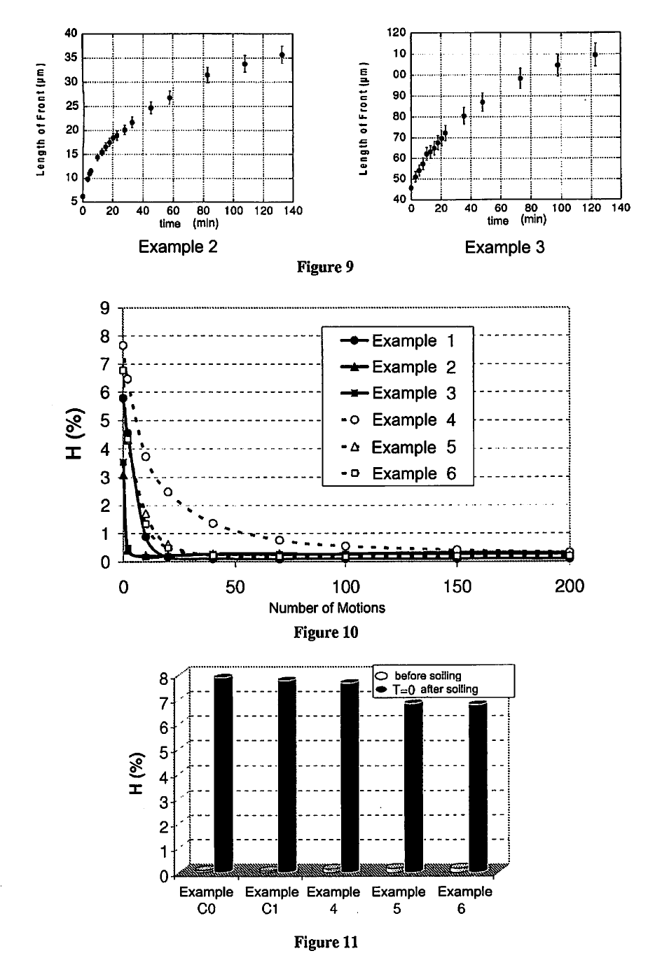

FIG. 9 represents the length of this liquid front as a function of time, and shows its development.

In the present application, mesoporous materials (coatings or films) are defined as solids comprising in the structure thereof pores having a size ranging from 2 to 50 nm, that are called mesopores, that is to say at least one part of the structure thereof comprises mesopores. Those mesopores preferably have a size ranging from 3 to 30 nm. Such pore size is an intermediate size between macropore size (>50 nm) and micropore size (<2 nm, materials of the zeolite type).

A microporous material is also defined as a solid comprising in the structure thereof pores having a size <2 nm, that is to say at least one part of the structure thereof comprises micropores. These definitions are those of the IUPAC Compendium of Chemistry Terminology, 2^{nd} Ed., A. D. McNaught and A. Wilkinson, RSC, Cambridge, UK, 1997.

As agreed herein, a material which comprises both micropores and mesopores will be referred to as mesoporous material. In the present application, a microporous material therefore does not comprise mesopores.

In the present application, a porous material is defined as a solid comprising in the structure thereof micropores and/or mesopores, that is to say at least one part of the structure thereof comprises micropores and/or mesopores.

Mesopores and micropores may be empty, that is to say filled with air, or be only partially empty.

Mesoporous materials and their preparation have been extensively described in the literature, especially in Science 1983, 220, 365371 or The Journal of Chemical Society, Faraday Transactions 1985, 81. 545-548. Microporous materials are also well known, and may be obtained either by not using any pore forming agent during their preparation, or by using a sufficiently low amount thereof so as to avoid the formation of mesopores. Following paragraphs are mainly dedicated to mesoporous coatings, however the same starting materials and the same general methods may be used for obtaining microporous materials.

Mesoporous materials may be structured. A structured material is defined in the present application as a material comprising an organized structure, characterized more specifically by the presence of at least one diffraction peak in a diffraction pattern of X-rays or neutrons, which is associated with a repetition of a distance that is specific to the material, called spatial repetition period of the structured system.

In the present application, a mesostructured material is defined as a structured material with a spatial repetition period ranging from 2 to 70 nm, preferably from 2 to 50 nm.

Structured mesoporous materials are a specific class of mesostructured materials. These are mesoporous materials with an organized spatial arrangement of the mesopores that are present in the structure thereof, leading therefore to a spatial repetition period.

The traditional method for preparing mesoporous (optionally structured) and microporous films, is the sol-gel process. It comprises the preparation of a not much polymerized sol based on an inorganic material such as silica, starting from an inorganic precursor that will be described in more details hereunder, such as a tetraalkoxysilane, in particular tetraethoxysilane (TEOS). This sol also contains water, an organic solvent typically polar in nature such as ethanol, optionally a hydrolysis and/or a condensation catalyst, and optionally a pore forming agent, most of the time in an acidic medium. The presence of the pore forming agent is absolutely required for mesoporous materials.

A film made from the precursor sol is then deposited onto a support main surface, and the deposited film is optionally consolidated. Removing the pore forming agent, when used in a sufficient amount, forms a mesoporous film.

When the pore forming agent is an amphiphilic agent, for example a surfactant, it acts as a structuring agent and typically leads to structured materials.

The pore size in the end material depends on the size of the pore forming agent which is entrapped or encapsulated within the silica network. When a surfactant is used, the pore size in the solid is relatively large because the silica network relies on micelles, that is to say on colloidal particles, formed by the surfactant. Inherently, micelles are larger than their components, so that using a surfactant as a pore forming agent typically produces a mesoporous material, if the surfactant is used with a high enough concentration.

When the pore forming agent is not an amphiphilic agent, it does not typically form micelles under these reaction conditions and does not typically result in structured materials.

Once the inorganic network is formed around the mesopores that contain the pore forming agent, such pore forming agent may be removed from the material, thus typically leading to a mesoporous material. If the pore forming agent amount used is too low, a microporous material is obtained. In the present application, a material may be referred to as being mesoporous as soon as the pore forming agent used for preparing the same has been removed at least partially from at least one part of this material, that is to say at least one part of this material comprises mesopores that are at least partially empty.

Mesoporous films which do not comprise a pore forming agent anymore and the pores of which have not been filled with other compounds have pores that are said to be “empty”, that is to say filled with air, and possess the properties resulting therefrom, i.e. especially a low refractive index as well as a low dielectric coefficient.

The matrix forming the porous coating, preferably the mesoporous coating, is a polysiloxane matrix. It comprises —Si—O—Si— chain members.

Preferably, the polysiloxane matrix is a silica-based matrix. As used herein, a silica-based matrix means a matrix obtained from a composition containing a precursor comprising at least one silicon atom bound to 4 hydrolyzable (or hydroxyl) groups. Such a matrix comprises tetraoxysilane groups.

A suitable sol to be used in the present invention to form the silica-based porous matrix comprises:

at least one inorganic precursor agent of formula:

Si(X)₄ (I)

wherein the X groups, being the same or different, are hydrolyzable groups preferably selected from —O—R alkoxy, in particular C₁-C₄ alkoxy, —O—C(O)R acyloxy groups, wherein R is an alkyl radical, preferably a C₁-C₆ alkyl radical, preferably a methyl or an ethyl radical, and halogens such as Cl, Br and I and combinations of these groups; or a hydrolyzate of this precursor agent;
at least one organic solvent;
at least one pore forming agent;
water and optionally a hydrolysis catalyst for the X groups.

Compound (I) is the precursor for a silica matrix or a silicate matrix with at least one metal. Preferably, The X groups are alkoxy groups, and in particular methoxy or ethoxy groups, and more preferably ethoxy groups.

Preferred compounds (I) are tetraalkyl orthosilicates. Amongst them, tetraethoxysilane (or tetraethyl orthosilicate) Si(OC₂H₅)₄ abbreviated TEOS, tetramethoxysilane Si(OCH₃)₄ abbreviated TMOS, or tetra-isopropoxysilane Si(OC₃H₇)₄ abbreviated TPOS will be advantageously used, and preferably TEOS.

Inorganic precursor agents of formula (I) that are present in the sol generally account for about 10 to 30% by weight of the total weight (including all other compounds that are present in the precursor sol, in particular the solvent) of the precursor sol.

The medium in which the precursor agent of formula (I) is present is typically an acidic medium, the acidic character of the medium being obtained through addition, for example, of an inorganic acid, typically HCl or of an organic acid such as acetic acid, preferably HCl. This acid acts as a hydrolysis and condensation catalyst by catalyzing the hydrolysis of the X groups of the compound of formula (I).

According to a specific embodiment, polysiloxane matrix has a hydrophobic character.

A method for imparting to the matrix a hydrophobic character is to use as the polysiloxane matrix-forming sol, a sol comprising, in addition to compound (I):

at least one hydrophobic precursor agent bearing at least one hydrophobic group, preferably a silane type reactant, in particular an alkoxysilane bearing at least one hydrophobic group directly contacting silicon.

at least one organic solvent;

at least one pore forming agent;
water and optionally a hydrolysis catalyst for the hydrolyzable groups.

As used herein, “hydrophobic groups” are intended to mean combinations of atoms that are not prone to association with water molecules, especially through hydrogen bonding. These are typically non polar organic groups, with no charged atoms. Alkyl, phenyl, fluoroalkyl, perfluoroalkyl, (poly)fluoro alkoxy[(poly)alkylenoxy]alkyl, trialkylsilyloxy groups and hydrogen atom are therefore included in this category. Alkyl groups are the most preferred hydrophobic groups.

Hydrophobic precursor agents are preferably directly added to the precursor sol, typically as a solution in an organic solvent and are preferably selected from compounds and combinations of compounds of formula (II) or (III):

(R¹)ₙ₁(R²)ₙ₂M (II)

or

(R)ₙ₃(R⁴)ₙ₄M-R′-M(R⁵)ₙ₅(R⁶)ₙ₆ (III)

wherein:
M represents a tetravalent metal or metalloid, for example Si, Sn, Zr, Hf or Ti, preferably silicon.
R¹, R³ and R⁵, being the same or different, represent saturated or unsaturated, hydrocarbon hydrophobic groups, preferably C₁-C₈ groups and more preferably C₁-C₄ groups, for example an alkyl group, such as methyl or ethyl, a vinyl group, an aryl group, for example phenyl, optionally substituted, especially by one or more C₁-C₄ alkyl groups, or represent fluorinated or perfluorinated analog groups of the previously mentioned hydrocarbon groups, for example fluoroalkyl or perfluoroalkyl groups, or a (poly)fluoro or perfluoro alkoxy[(poly)alkylenoxy]alkyl group. Preferably R¹, R³ and R⁵ represent a methyl group.
R², R⁴ and R⁶, being the same or different, represent hydrolyzable groups, preferably chosen from —O—R alkoxy, in particular C₁-C₄ alkoxy, —O—C(O)R acyloxy groups, wherein R is an alkyl radical, preferably a C₁-C₆ alkyl radical, preferably a methyl or an ethyl radical, and halogens such as Cl, Br and I. These are preferably alkoxy groups, especially methoxy or ethoxy, and more preferably ethoxy groups.
R′ represents a divalent group, for example an optionally substituted, linear or branched alkylene group, an optionally substituted cycloalkylene group, an optionally substituted arylene group, or a combination of the previously mentioned groups of the same category and/or of various categories, especially cycloalkylenealkylene, biscycloalkylene, biscycloalkylenealkylene, arylenealkylene, bisphenylene and bisphenylenealkylene groups. Preferred alkylene groups include linear C₁-C₁₀ alkylene groups, for example a methylene group —CH₂—, an ethylene group —CH₂—CH₂—, a butylene or a hexylene, especially 1,4-butylene and 1,6-hexylene and branched C₃-C₁₀ alkylene radicals such as 1,4-(4-methyl pentylene), 1,6-(2,2,4-trimethyl hexylene), 1,5-(5-methyl hexylene), 1,6-(6-methyl heptylene), 1,5-(2,2,5-trimethyl hexylene), 1,7-(3,7-dimethyl octylene), 2,2-(dimethylpropylene) and 1,6-(2,4,4-trimethyl hexylene) radicals. Preferred cycloalkylene radicals include cyclopentylene and cyclohexylene radicals, optionally substituted especially by alkyl groups. R′ represents preferably a methylene, ethylene or phenylene group.
n₁ is an integer from 1 to 3, n₂ is an integer from 1 to 3, n₁+n₂=4,
n₃, n₄, n₅, and n₆ are integers from 0 to 3 with the proviso that n₃+n₅ and n₄+n₆ both are different from zero, and n₃+n₄=n₅+n₆=3.

Preferred hydrophobic precursor agents are alkylalkoxysilanes, preferably alkyltrialkoxysilanes, such as methyltriethoxysilane (MTEOS, CH₃Si(OC₂H₅)₃), vinylalkoxysilanes, especially vinyltrialkoxysilanes, such as vinyltriethoxysilane, fluoroalkyl alkoxysilanes, preferably fluoroalkyl trialkoxysilanes such as 3,3,3-trifluoropropyltrimethoxysilane of formula CF₃CH₂CH₂Si(OCH₃)₃ and arylalkoxysilanes, preferably aryltrialkoxysilanes. The most preferred hydrophobic precursor agent is methyltriethoxysilane (MTEOS).

Generally, the molar ratio between the hydrophobic precursor agent and the inorganic precursor agent of formula (I) varies from 10/90 to 50/50, more preferably from 20/80 to 45/55, and is preferably 40/60, especially when using MTEOS as hydrophobic precursor agent in the precursor sol.

Typically, the hydrophobic precursor agent bearing at least one hydrophobic group may represent from 1 to 50% by weight of the precursor sol total weight, and the weight ratio between pore forming agents and inorganic precursor agents plus hydrophobic precursor agents bearing at least one hydrophobic group optionally added to the precursor sol, varies from 0.01 to 5, preferably from 0.05 to 1.

In one another embodiment, coatings according to the invention have a polysiloxane matrix prepared from a sol not containing any hydrophobic precursor agent bearing at least one hydrophobic group. In this embodiment, the porous coating matrix formed during the initial polymerization step is therefore not a hydrophobic matrix.

As will be seen in the examples, porous coatings having a polysiloxane matrix prepared from a sol not containing any hydrophobic precursor agent possess better antisoiling and/or self-cleaning properties than coatings obtained using a hydrophobic precursor agent.

However, the efficiency of these coatings remains outstanding and better than when submitting the porous coating to a post-treatment through reaction with a hydrophobic reactant compound, which is another way to make a polysiloxane matrix hydrophobic, and which will be described hereafter.

Moreover, these porous coatings, the matrix of which has been prepared from a sol comprising a hydrophobic precursor agent, have properties that remain more stable over time, in particular as to the refractive index, and have a limited water absorption.

Organic solvents or mixtures of organic solvents to be suitably used for preparing the precursor sol according to the invention are all classically employed solvents, and more particularly polar solvents, especially alkanols such as methanol, ethanol, isopropanol, isobutanol, n-butanol and mixtures thereof. Other solvents, preferably water-soluble solvents, may be used, such as 1,4-dioxane, tetrahydrofurane or acetonitrile. Ethanol is the most preferred organic solvent.

Generally, the organic solvent represents from 40 to 90% by weight of the precursor sol total weight. Water contained in the precursor sol represents typically from 10 to 20% by weight of the precursor sol total weight.

The pore forming agent of the precursor sol may be an amphiphilic or non amphiphilic pore forming agent. Generally, it is an organic compound. It may be used alone or in admixture with other pore forming agents.

To be suitably used as non amphiphilic pore forming agents in the present invention are to mention:
synthetic polymers such as polyethylene oxide, with a molecular weight ranging from 50000 to 300000, polyethylene glycol, with a molecular weight ranging from 50000 to 300000,
gamma-cyclodextrin, lactic acid, and other biological materials such as proteins or sugars such as D-glucose or maltose.

The pore forming agent is preferably an amphiphilic agent of the surfactant type. One crucial characteristic of such a compound is its ability to form micelles in solution after the solvent evaporation concentrating the solution, to result in the formation of an inorganic matrix-mesostructured film.

Surfactant compounds may be non ionic, cationic, anionic or amphoteric in nature. These surfactants are for most of them commercially available.

Surfactant compounds for use in the present invention are those described in the application WO 2007/088312. Preferred pore forming agents are cetyltrimethylammonium bromide (CTAB) and diblock- or triblock-copolymers, preferably triblock-copolymers, of ethylene oxide and propylene oxide.

As a rule, the pore forming agent represents from 2 to 10% of the precursor sol total weight. Typically, the molar ratio of pore forming agents to precursor agents of formula (I) added to the precursor sol varies from 0.01 to 5, preferably from 0.05 to 1, more preferably from 0.05 to 0.25.

The step of depositing the precursor sol film onto the main surface of the support may be carried out using any conventional method, for example through dip coating, spray coating or spin coating, preferably through spin coating. This deposition step is preferably carried out under an atmosphere having a relative humidity (RH) varying from 40 to 80%.

The optional step of consolidating the film structure of the deposited precursor sol consists in completing the removal of the solvent or mixture of organic solvents from the precursor sol film and/or the possible water excess, and in continuing the condensation of some residual silanol groups that are present in the sol, typically by heating said film. This step is preferably carried out by heating at a temperature ≦150° C., preferably ≦130° C., more preferably ≦120° C. and even more preferably ≦110° C.

The pore forming agent removal step may be partial or complete. Preferably, this step removes at least 90% by weight of the total weight of the pore forming agent present in the film as a result of the preceding step, more preferably at least 95% by weight and even more preferably at least 99% by weight. Such removal is effected by any suitable method, for example through high temperature calcination (heating at a temperature typically of about 400° C.), but preferably through methods enabling to work at low temperatures, that is to say at a temperature ≦150° C., preferably ≦130° C., more preferably ≦120° C. and even more preferably ≦110° C. To be especially mentioned are the known methods, such as solvent extraction or supercritical fluid extraction, ozone degradation, plasma treatment for example with oxygen or argon, or corona discharge or photodegradation through exposure to the light radiation, especially UV. The latter method is especially described in the application US 2004/0151651. A supercritical fluid extraction (typically supercritical CO₂) of a surfactant within a mesostructured material is described in the patent JP 2000-226572.

Preferably, the removal of the pore forming agent is effected through extraction. Many successive extractions may be conducted, so as to obtain the expected extraction level.

In one embodiment, extraction is effected by means of an organic solvent or a mixture of organic solvents by dipping the formed and optionally consolidated film into a solvent or a mixture of solvents, preferably organic solvents, brought to a temperature ≦150° C. A solvent is preferably used to reflux. Any solvent which boiling point ≦150° C., preferably ≦130° C., more preferably ≦120° C. and even more preferably ≦110° C. may be appropriate. Preferred solvents include alkanols, in particular ethanol (Bp=78° C.), alkylketones, in particular acetone (Bp=56° C.) and chloroalkanes such as dichloromethane or chloroform. A non toxic solvent is preferably used, such as acetone or ethanol.

In one preferred embodiment, the solvent extraction may also be efficiently carried out at room temperature, under stirring, using ultrasounds.

The extraction of the pore forming agent by means of an organic solvent enables to better control the porous film final thickness as compared to calcination and is more convenient for polymer substrates.

The way to prepare mesoporous coatings having a silica-based matrix is described in more details in the applications WO 2006/021698, WO 2007/088312 and WO 2007/090983 in the name of the applicant, which are incorporated as a reference into the present application.

In one particular embodiment, coatings according to the invention have a silica-based matrix comprising silanol groups, which has not been treated with a hydrophobic reactive compound bearing at least one hydrophobic group.

Another method for obtaining a matrix having a hydrophobic character will be described hereunder. According to this other embodiment of the invention, the porous film the preparation of which is described hereabove is treated with at least one hydrophobic reactive compound bearing at least one hydrophobic group, in order to impart or reinforce the hydrophobic character thereof. The hydrophobic reactive compound does react with silanol groups and a treatment with this compound does result in a silica matrix the silanol groups of which have been derivatized into hydrophobic groups.

The definition for hydrophobic groups is the same as the one used for the previously defined hydrophobic precursor agents.

This additional treating step, called “post-synthetic grafting”, is carried out after the step of depositing the film of the precursor sol onto a support's main surface or, if present, after the step of consolidating the deposited film. It makes it possible to reinforce the hydrophobic character of the film, and to thus limit the amount of water that is adsorbed into the pores of the material.

It may be carried out during the step of removing the pore forming agent, after the step of removing the pore forming agent, or even before the step of removing the pore forming agent.

The hydrophobic reactive compounds bearing at least one hydrophobic group particularly suitable for the present invention are compounds from a tetravalent metal or metalloid, preferably silicon, comprising just one function capable of reacting with the hydroxyl groups that remain in the film, in particular a Si—Cl, Si—NH—, Si—OR function, wherein R is an alkyl, preferably a C₁-C₄ alkyl group.

Preferably, said hydrophobic reactive compound is selected from compounds and mixtures of compounds of formula (IV):

(R′^{1′})₃(R′²)M (IV)

wherein:
M represents a tetravalent metal or metalloid, for example Si, Sn, Zr, Hf or Ti, preferably silicon.
R′¹ groups, being the same or different, represent saturated or unsaturated, hydrocarbon hydrophobic groups, preferably C₁-C₈ and more preferably C₁-C₄, for example alkyl groups, such as methyl or ethyl, a vinyl group, an aryl group, for example phenyl, optionally substituted groups, especially by one or more C₁-C₄ alkyl groups, or represent fluorinated or perfluorinated analog groups of the previously mentioned hydrocarbon groups, for example fluoroalkyl or perfluoroalkyl groups, or (poly)fluoro or perfluoro alkoxy[(poly)alkylenoxy]alkyl groups. Preferably, R′¹ is a methyl group.
R′² represents a hydrolyzable group, preferably selected from —O—R″ alkoxy, in particular C₁-C₄ alkoxy, —O—C(O)R″ acyloxy groups, wherein R″ is an alkyl radical, preferably a C₁-C₆ alkyl radical, preferably a methyl or an ethyl, an amino optionally substituted by one or two functional groups, for example an alkyl or a silane group, and halogens such as Cl, Br and I. These are preferably alkoxy groups, especially methoxy or ethoxy, chloro or —NHSiMe₃.

As hydrophobic reactant compound, one may advantageously use fluoroalkyl chlorosilane, especially tri(fluoroalkyl)chlorosilane or fluoroalkyl dialkyl chlorosilane such as 3,3,3-trifluoropropyldimethyl chlorosilane of formula CF₃—CH₂—CH₂—Si(CH₃)₂Cl, alkylalkoxysilane, especially trialkylalkoxysilane, such as trimethylmethoxysilane (CH₃)₃SiOCH₃, fluoroalkyl alkoxysilane, especially tri(fluoroalkyl)alkoxysilane or fluoroalkyl dialkyl alkoxysilane, alkylchlorosilane, especially trialkylchlorosilane, such as trimethylchlorosilane, trialkylsilazane or hexaalkyldisilazane.

In a preferred embodiment, the hydrophobic reactive compound comprises a trialkylsilyl group, preferably a trimethysilyl group and a silazane group, in particular a disilazane group. The most preferred hydrophobic reactive compound is 1,1,1,3,3,3-hexamethyldisilazane (CH₃)₃Si—NH-Si(CH₃)₃, abbreviated as HMDS.

This post-synthetic grafting step is described in more details in the applications US 2003/157311, WO 99/09383 and WO 2007/088312. It may be carried out on a porous coating, the matrix of which already has a hydrophobic character, due to the fact it has been obtained from a sol comprising a hydrophobic precursor agent.

A crucial characteristic of the porous film according to the invention, whatever the hydrophobic or non hydrophobic nature of the matrix thereof, for it to be used for its antisoiling properties, is its volume porosity rate, which should be at least 25%, preferably at least 30%, more preferably at least 40%, even more preferably at least 50%, but lower than or equal to 70%. Below 25%, the porosity becomes insufficient for inducing interesting antisoiling effects, especially a sufficient cleanability, whereas above 70%, the structure becomes increasingly weaker and tends to collapse. In the present application, porosity rates are expressed as volume rates.

The porosity rate represents the void fraction in the porous material according to the invention. This comprises mesopores, when present, but also, automatically, micropores. It may be controlled by adjusting the pore forming agent amount within the silica-based matrix: the higher the pore forming agent concentration, the higher the porosity is (after removal of the pore forming agent).

Preferably, the porous material according to the invention does not comprise macropores. The porosity of the porous material according to the invention represents typically the sum of the microporosity plus the mesoporosity.

Another crucial characteristic of the porous film according to the invention, whatever the hydrophobic or non hydrophobic nature of the matrix thereof, for it to be used for its antisoiling properties, is that it has such a volume that the potential filling ratio of said porous coating volume by oleic acid (a component that is representative of organic soils) is at least 25% by volume. This means that the volume porosity rate thereof is necessarily higher than or equal to 25%.

Preferably, this potential filling ratio of the porous coating volume by oleic acid is at least 30% by volume, more preferably at least 40%, even more preferably at least 45%, and most preferably at least 50%. This potential filling ratio of the porous coating volume by oleic acid is lower than or equal to 70% by volume, preferably lower than or equal to 65% and more preferably lower than 60%.

The potential filling ratio of the porous coating volume by oleic acid is a parameter for measuring the accessibility of the pores to oleic acid, a component that mimics the soil behavior (typically the sebum, comprising from 20 to 30% thereof). In other words, the porous coating according to the invention has a porosity rate ranging from 25 to 70% by volume, and the porous volume accessible to a component representative of organic soils, oleic acid, represents at least 25% of the porous coating total volume.

This potential filling ratio of the coating, that is to say its ability to be filled, may easily be determined by the person skilled in the art by carrying out the oleic acid filling test explained in detail in the experimental section of the present application. It represents the ratio between the coating's volume which can be filled with oleic acid divided by the coating total volume.

If the oleic acid ability to penetrate within the microporous, and optionally mesoporous network, is insufficient, the coating will not have sufficient antisoiling properties, in particular a good cleanability and self-cleaning ability.

The antisoiling properties of the porous coatings according to the invention will now be described. As opposed to antisoiling coatings that are traditionally used for glass protection, especially for ophthalmic glasses, which are characterized by a high ability to repel water and/or organic liquids (high static contact angles), the antisoiling properties of the coatings according to the invention may express in two different ways: cleanability improvement (ability to be cleaned) of the substrate onto which the coating is deposited and/or acquisition of self-cleaning properties via such substrate. Materials according to the invention typically possess these two types of properties simultaneously. These are the first coatings described that combine “self-cleaning” and “ease of cleaning” properties, and that are not photocatalytic in nature.

A coating having self-cleaning properties (which is self-cleaning) is interesting in that the surface it covers has to be washed less frequently than traditional surfaces: it acts as a soil retention retarder and lowers the wearer's perception of the soil as compared to a traditional antisoiling coating, and this, as soon as a soil deposit forms. With optical glasses, the wearer does not need to be active for the coating to react against soil. The self-cleaning coating according to the invention reduces the involvement of the goggles wearer in the cleaning of his glasses, as well as the visual discomfort due to soils (reduced soil diffusion).

The self-cleaning characteristics of the coatings according to the invention may be evaluated by measuring the diffusion rate in transmission as a function of time, with a transparent substrate. Without wishing to be bound by any theory, it can be thought that the decrease in the diffusion rate which is observed results from the soil impregnation into the pores: since the porosity make it possible to drain the soil's liquid part, the latter becomes less visible.

A coating possessing improved cleanability properties makes the surface it covers easier and faster to clean (easy to clean). With optical glasses, it is easier for the wearer to clean the coating by means of a wiping cloth.

The improved cleanability characteristics of the coatings according to the invention may be evaluated by measuring the diffusion rate in transmission as a function of the number of wiping motions, in the case of a transparent substrate. They may result from the fact that the soil's liquid part is drained to the porous structure. When the soil comprises a solid part, said part remains typically on the surface of the coating and is easier to clean.

With porosity rates ranging from 25 to 70%, cleanability and self-cleaning ability are better as the porosity rate increases.

Moreover the inventors discovered that even if the antisoiling properties of the coatings used according to the present invention are essentially bound to their ability to drain organic residues from their surface, thanks to their porous nature and to the accessibility of their pores, said antisoiling properties are also bound, to a lesser extent, to their ability to decompose part of the organic residue deposits.

The silanol functions of the silica-based matrix may indeed catalyze the degradation, in particular the hydrolysis, of organic soil components such as waxes, triglycerides or sterol esters, in particular esters. This causes the chain length of such components to be reduced, and contributes to change the soil morphology by liquefying it. The soil therefore spreads more easily on the surface of the coating, thus facilitating the cleaning thereof, and is absorbed into the porous structure more easily.

Organic fatty acid esters, hydrolyzable by nature, are present for example in sebum or sweat. The hydrolysis reaction of fatty acid esters catalyzed by the silanol groups of a porous coating according to the invention may be evidenced by following the transformation of the ester function to an acid function through infrared spectroscopy. Such hydrolysis reaction is however relatively slow and only affects part of the organic soil components (around 30% of sebum is not hydrolyzable, this percentage being variable from one individual to another).

As opposed to the photocatalytic coatings described in the application WO 2003/087002, antisoiling coatings according to the invention have permanent antisoiling properties (independently from the received light irradiation), and the self-cleaning process kinetics is faster. A substrate coated with the antisoiling layer according to the invention is active against soil under highly diversified environmental conditions.

The porous material according to the invention does not comprise oxides that might be photocatalytic such as titanium dioxide TiO₂, zinc oxide ZnO, tin oxide or tungsten oxide, incorporated into the mesoporous structure thereof, and, more generally, has no photocatalytic properties.

In case of successive soil depositions and wipings, it becomes more difficult to clean the porous coating according to the invention. As depositions follow on each other, cleaning requires a longer wiping time to attain the same diffusion level, since the porous structure fills itself progressively and cannot receive as much soil as a yet unsoiled porous coating. However, the antisoiling coating according to the invention should undergo several successive depositions to become less efficient as regards cleanability than commercially available antisoiling coatings that are based on fluorosilanes or fluorosilazanes. Whatever the number of depositions effected, it remains easier to clean than an abrasion-resistant coating based on silanes or than a microporous coating that would not have the characteristics of porosity and pore accessibility to oleic acid of the porous coatings according to the invention.

The porous coating according to the invention may also advantageously be regenerated, that is to say may recover an antisoiling property performance comparable to its initial state, by simple washing, for example using a surfactant (soap), or more preferably, using an organic solvent such as acetone or an alcohol (for example isopropanol). The regeneration may be carried out several times, which means that the porous coating recovers its initial properties even after several soiling-washing cycles.

Thus, the invention further relates to the use of a porous coating such as previously described having been regenerated, that is to say a porous coating according to the invention having beforehand received at least one soil deposition, thereafter having been washed, especially using a surfactant and/or an organic solvent.

If the silica-based matrix has been functionalized with a hydrophobic reactive compound bearing at least one hydrophobic group, several changes occur as regards the structure and the properties of the porous materials.

If a post-treatment is fully achieved, the thus prepared porous coating no longer has silanol functions that could contribute to the hydrolysis of the soil components. Upon HMDS-mediated functionalization, these groups are replaced with Si—O—Si(CH₃)₃ groups. The porous coating having a hydrophobic matrix is thus less capable of causing a decrease in the diffusion rate through draining of the soil within the pores, and less prone to facilitate the spreading and therefore the cleaning thereof.

Secondly, this porous hydrophobic coating has a porosity rate that is typically lower than that of the same coating prior to being rendered hydrophobic. Indeed, the porous volume decreases because of the porous structure wall densification which results in a decrease in the microporosity. The accessibility to the porosity is thus reduced, as well as the volume accessible to soil.

Finally, since the silica functionalized with a hydrophobic agent has a hydrophobic character, the affinity between the surface of the porous coating and the soil is modified. The coating the surface of which has been submitted to a hydrophobation treatment is typically less able to spread the soil.

The porous coatings according to the invention that have been functionalized post-synthesis by a hydrophobic agent possess self-cleaning properties that are typically lower than prior to being rendered hydrophobic. They are especially impregnated less rapidly by the soil. However they belong to the scope according to the invention for use as antisoiling coatings, on the one hand because of their self-cleaning surface, even if less efficient, and on the other hand, and above all, thanks to their cleanability properties, which are still very interesting.

If the polysiloxane matrix of the porous coating according to the invention is prepared from a sol comprising a hydrophobic precursor agent bearing at least one hydrophobic group (the typical example is a TEOS/MTEOS matrix with MTEOS/TEOS molar ratios lower than 50%), the matrix comprises hydrophobic groups, but also a fraction of free hydroxy groups.

The inventors could observe that, for hydrophobic porous matrices of this type, even if the cleaning effect is slower than with a non hydrophobic matrix, outstanding self-cleaning results are obtained over time, as compared with the grafting post-treatment.

Moreover, as opposed to a matrix treated with a hydrophobic agent in post-treatment, this matrix has a hybrid behavior which enables, as is the case with a non hydrophobic matrix, to attenuate the diffusion effect, and therefore the visual discomfort, immediately after soil deposition, which is not the case with the traditionally used hydrophobic and oleophobic layers.

The porous coatings according to the invention, whatever the hydrophobic or non hydrophobic nature of the matrix thereof, may be easily regenerated after having been soiled.

In a first embodiment, the porous coating used in the present invention for its antisoiling properties is a mesoporous coating. The presence of mesopores promotes the characteristic of accessibility to oleic acid, which may be explained by the presence of a sufficient porous volume and of a sufficient pore size to enable the access to soils. This embodiment is the preferred embodiment according to the invention. Indeed, a mesoporous material possesses better cleanability and self-cleaning characteristics than a microporous material.

In this first embodiment, the porous coating therefore comprises generally well calibrated mesopores, i.e. of 4 nm diameter (micelle cavities), but also micropores, having typically a diameter of a few angstroms, located within matrix walls and typically non monodispersed, while respecting a porosity rate within the general limit ranges defined hereabove. Regarding the porous morphology of these films, typically, with a CTAB/TEOS ratio of 0.1 and without post-treatment, mesopores represent typically ⅔ of the void volume and micropores represent typically ⅓ of the void volume.

In a second embodiment, the porous coating used in the present invention for its antisoiling properties is a microporous coating. In this second embodiment, the porous coating only comprises micropores, and should have a porosity rate within the general limit ranges defined hereabove, but also a sufficient potential filling ratio of the coating's volume by oleic acid.

Without wishing to be bound by any particular theory, the inventors believe that below a certain micropore size, the microporous network becomes inaccessible to oleic acid, which would explain why some microporous coatings are not within the scope according to the invention.

Preferably, the porous coating according to the invention, when it comprises a hydrophobic matrix, is a mesoporous coating.

When the coating is made hydrophobic by a post-treatment, it is moreover preferred that the porosity rate of the precursor thereof, the coating with a silica-based matrix that is submitted to the hydrophobation reaction, be higher than 30%, more preferably higher than 40%, and even more preferably higher than 50%.

In their final state, the porous films according to the invention typically have a maximum thickness of about a few μm, typically 5 μm, and typically a thickness ranging from 50 nm to 5 μm, and preferably from 50 to 500 nm and even more preferably from 80 to 500 nm. Obviously, it is possible to successively deposit several films so as to obtain a multilayered film with the expected thickness. The antisoiling properties will be all the more pronounced as the thickness of the porous film will be high, although an antisoiling threshold may possibly exist beyond a certain thickness, depending on the nature of the porous film.

The porous coatings according to the invention may be used for imparting antisoiling properties to various items, transparent or not, such as lenses or optical lens blanks, preferably lenses or ophthalmic lens blanks, optical fibers, glazing used for example in the field of aeronautics, in the field of building, transports (automotive . . . ), or in the field of interior arrangement, for example double glazing, windscreen, glass for aquarium, greenhouse, mirror or store window, glass panels for kitchen, touch screens, display screens, handling articles such as handles, wheels, keyboards, pens, furniture, or any other analog items, this list being of course non limitative.

The support onto which the porous films are deposited may be made from any solid, transparent or non transparent material, such as mineral glass, ceramics, glass-ceramic, metal or organic glass, for example a thermoplastic or a thermosetting plastic material. Preferably, the support is a substrate of mineral or organic glass, preferably transparent. More preferably, the support is a substrate made from a transparent plastic material.

Suitable thermoplastic materials for use as substrates include (meth)acrylic (co)polymers, in particular methyl poly(methacrylate) (PMMA), thio(meth)acrylic (co)polymers, polyvinylbutyral (PVB), polycarbonates (PC), polyurethanes (PU), poly(thiourethanes), polyol allylcarbonate (co)polymers, thermoplastic copolymers of ethylene/vinyl acetate, polyesters such as ethylene poly(terephthalate) (PET) or butylene poly(terephthalate) (PBT), polyepisulfides, polyepoxides, copolymers of polycarbonates/polyesters, copolymers of cycloolefins such as copolymers of ethylene/norbornene or ethylene/cyclopentadiene and combinations thereof.

As used herein, a (co)polymer is intended to mean a copolymer or a polymer. A (meth)acrylate means an acrylate or a methacrylate.

Preferred substrates according to the invention include substrates obtained by polymerization of alkyl (metha)crylates, in particular C₁-C₄ alkyl (meth)acrylates, such as methyl (meth)acrylate and ethyl (meth)acrylate, polyethoxylated aromatic (meth)acrylates such as polyethoxylated bisphenol di(meth)acrylates, allyl derivatives such as aliphatic or aromatic, linear or branched, polyol allylcarbonates, thio(meth)acrylates, episulfides and precursor mixtures of polythiols/polyisocyanates (for obtaining polythiourethanes).

Suitable examples of (co)polymers of polyol allyl carbonates include (co)polymers of ethyleneglycol bis(allyl carbonate), diethyleneglycol bis 2-methyl carbonate, diethyleneglycol bis(allyl carbonate), ethyleneglycol bis(2-chloro allyl carbonate), triethyleneglycol bis(allyl carbonate), 1,3-propanediol bis(allyl carbonate), propyleneglycol bis(2-ethyl allyl carbonate), 1,3-butenediol bis(allyl carbonate), 1,4-butenediol bis(2-bromo allyl carbonate), dipropyleneglycol bis(allyl carbonate), trimethyleneglycol bis(2-ethyl allyl carbonate), pentamethyleneglycol bis(allyl carbonate), isopropylene bisphenol A bis(allyl carbonate).

Especially recommended substrates include those substrates obtained by (co)polymerization of diethyleneglycol bisallylcarbonate, marketed, for example, under the trade name CR 39® by the PPG Industries company (ORMA° lenses from ESSILOR).

Further especially recommended substrates also include substrates obtained by polymerization of thio(meth)acrylic monomers, such as those described in the French patent application FR 2734827 and polycarbonates.

Obviously, substrates may be obtained by polymerization of mixtures comprising the previously mentioned monomers, or may also comprise mixtures of these polymers and (co)polymers.

The porous films according to the invention may be formed at least on part of the main surface of a bare support (substrate), that is to say non coated, or already coated with one or more functional coating(s).

Preferably, the support according to the invention is an ophthalmic lens substrate. In ophthalmic optics, it is well known to coat a main surface of a substrate made from a transparent organic material, for example an ophthalmic lens, with one or more functional coating(s) to improve the optical and/or mechanical properties of the final lens. Thus, the support main surface may be provided beforehand with a primer coating improving the impact resistance (impact-resistant primer) and/or the adhesion of the further layers in the end product, with an abrasion-resistant and/or scratch-resistant coating (hard coat), with an anti-reflection coating, with a polarized coating, with a photochromic coating, with an antistatic coating, with a tinted coating or with a stack made of two or more such coatings.

The primer coatings improving the impact resistance are preferably polyurethane latexes or acrylic latexes.

Abrasion- and/or scratch-resistant coatings are preferably hard coatings based on poly(meth)acrylates or silicones. Recommended hard abrasion- and/or scratch-resistant coatings in the present invention include coatings obtained from silane hydrolyzate-based compositions, in particular epoxysilane hydrolyzate-based compositions such as those described in the French patent application FR 2702486 and in the U.S. Pat. No. 4,211,823 and U.S. Pat. No. 5,015,523.

In one recommended embodiment, the porous film according to the invention is deposited onto a traditional monolayered or multilayered anti-reflection coating.

Since the porous film according to the invention has antisoiling properties, it is not useful to coat it with a hydrophobic and/or oleophobic layer (top coat). It typically forms the stack's outer layer of one or several layers deposited onto the surface of the substrate, that is to say the layer that is the most distant from the substrate.

The porous film according to the invention may also be deposited onto an abrasion-resistant coating, having a high refractive index (typically of from 1.55 to 1.65, preferably from 1.55 to 1.60), the porous film having then an anti-reflection function.

It is efficient in particular against soils of organic origin: finger marks, sweat (sebum), insect, etc, and mainly against finger marks and sweat.

The following examples illustrate hereafter the present invention without restraining the same. Unless otherwise mentioned, all percentages are expressed by weight. All refraction indices are expressed at 2=632.8 nm and T=20-25° C.

### EXAMPLES

### A) Reactants and Equipment Used for Synthesizing Porous Films

TEOS of formula Si(OC₂H₅)₄ has been employed as inorganic precursor agent of formula (I), and CTAB of formula C₁₆H₃₃N(CH₃)₃Br has been employed as pore forming agent. The hydrophobic reactive compound employed in some examples is hexamethyldisilazane (HMDS).

Sols were prepared by using absolute ethanol as organic solvent and diluted hydrochloric acid (so as to obtain a pH=1.25) as hydrolysis catalyst.

The hydrophobic precursor agent, when used, is MTEOS (methyltriethoxysilane).

Coatings were deposited onto glasses comprising a substrate for an ORMA® lens (ESSILOR) with 0.00, except for reflection measurements: −2.00, with a refractive index of 1.50, a thickness of 1.1 mm, with a radius of curvature ranging from 80 to 180 mm and a diameter ranging from 65 to 70 mm. This substrate was coated with the abrasion-resistant and scratch-resistant coating disclosed in Example 3 of the patent EP 0614957 (with a refractive index of 1.48 and a thickness of 3.5 μm), based on GLYMO, DMDES, colloidal silica and aluminium acetylacetonate.

### B) Porosity and Porous Morphology Analysis

Characterizing the porosity of the coatings prepared was effected by combining two methods: infrared ellipsometry and ellipsometric porosimetry. The first one enables to determine the refractive index of the silica-based matrix and the porosity rate (total porosity) of the coatings. It is described in detail in A. Brunet-Brunwater, S. Fisson, G. Vuye, J. Rivory J. Appl. Phys. 2000, 87, 7303-7309, and A. Brunet-Brunwater, S. Fisson, B. Gallas, G. Vuye, J. Rivory Thin Solid Films 2000, 377-378, 57-61.The second one enables to quantify micro- and mesoporous volumes. It is described in M. R. Baklanov, K. P. Mogilnikov, V. G. Polovinkin, F. N. Dultsev J. Vac. Sci. Technol. B 2000, 18, 1385-1391. A short review of this technique is given hereunder.

### Ellipsometric Porosimetry

The ellipsometric porosimetry enables to obtain adsorption isotherms on low-thickness coatings, by determining through ellipsometric measures the adsorbed amounts. As opposed to volumetric methods, it uses a condensation optical detection method. Upon adsorption, because of the nanometric size of the pores, the adsorbate, here ethanol, condenses at a pressure P that is lower than its saturation vapor pressure P₀. The density of the adsorbate, and thus its refractive index, substantially increase, which changes the optical properties of the film.

The substrate coated with the porous film is placed under vacuum in a temperature-regulated chamber (close to room temperature). The chamber is pumped up to 10⁻⁷ Torr. A first ellipsometric measurement is carried out. Vapor pressure P in the chamber is thereafter progressively increased until saturation (P₀) to obtain the adsorption range, than the pressure is reduced to measure desorption. After each pressure balancing step, an ellipsometric measure is carried out (under 75° incidence). The refractive index measured n is as follows:

n=(1−p)nₛ+xpn_{liq}+(1−x)pnᵥₐₚ

wherein x is the filling ratio of the porosity (0≦x≦1), p and nₛ are respectively the porosity rate and the refractive index of the silica-based matrix (both of them determined through infrared ellipsometry), the vapor index nᵥₐₚ is equal to 1 (low density), and it is considered that the refractive index n_{liq} of the adsorbate condensed in the pores is that of the macroscopic liquid.

The refractive index measured is directly bound to the filling ratio, which enables to obtain filling ratio isotherms with x=f(P/P₀). These curves are interpreted in the same way as adsorption isotherms obtained on powders (see F. Rouquerol, J. Rouquerol, K. Sing Adsorption by powders and porous solids. Principles, methodology and applications, Academic Press, 1999), and make it possible to determine the microporous volume, and, in the case of a mesoporous material, the mesoporous volume, as well as the diameter of the mesopores.

### C) Porous Coatings with a Silica-Based Non Hydrophobic Matrix

### 1. General Procedure for Preparing the Silica-Based Sol

The molar ratios of the silica sol components are as follows: TEOS/ethanol/HCl-H₂O=1:3.8:5. TEOS is hydrolyzed, then partially condensed by heating for one hour at 60° C. in an ethanol/diluted hydrochloric acid medium, in a fat flask provided with a cooling medium.

The silica sol obtained is made of polymer small clusters of partially condensed silica, comprising a large amount of silanol functions.

### 2. General Procedure for Depositing a Silica-Based Matrix Film

A pore forming agent stock solution was prepared comprising 48.7 g of CTAB per liter of ethanol. Its dissolution could be facilitated through the use of ultrasounds for a few seconds.

3 mL of the silica sol prepared hereabove, once back to room temperature, were added under stirring to a certain volume of CTAB stock solution, so that the CTAB/Si molar ratio be such as defined in Table 1. Thereafter, a few drops of the thus prepared mixture were spin coated onto a glass substrate or a silicon disk (2 minutes rotation at 3000 rpm, acceleration around 2000 rotations/minute/s), under a RH of 45-50% (T=18-20° C.). The substrate typically did not undergo any surface preparation. Such protocol enabled to prepare the porous films of Examples 1-3.

### 3. General Procedure for Consolidating the Film and Removing the Surfactant CTAB

The film was submitted thereafter to a heat treatment so as to advance the silica network polymerization degree (consolidation). The substrate coated with the film obtained in the paragraph 2 hereabove was heat consolidated in an oven to 100° C. for 12 h, then CTAB was removed through extraction with an organic solvent as follows. The substrate coated with the consolidated film was placed in the isopropanol-containing tank of an Elmasonic ultrasound delivery system at room temperature for 15 min. The ultrasound homogeneity was ensured by setting the apparatus “sweep” function on. CTAB could also be removed by placing the substrate coated with the consolidated film 3×15 min in an acetone-filled beaker arranged in an ultrasound tank. It should be noted that the characteristics indicated in Table 1 hereunder were measured on films having been calcinated to 450° C. instead of having been submitted to an extraction to remove the pore forming agent.

At the end of this step, a substrate was recovered, that was coated with a mesoporous film. The resulting films had a thickness of around 250 to 300 nm except for the reflection measurements (except example C1: 200 nm), for which 80-120 nm-thick films were used (absolute ethanol dilution). Thicknesses were measured by means of a profilometer.

### 4. Comparative Example

Comparative example C1 is different from Examples 1-3 in that no pore forming agent was used for making the film. No step of pore forming agent removal was thus carried out, but the film was also washed with isopropanol. It is preferred to conduct the heat consolidation step of the film of Example C1 at 70° C. rather than 100° C. as in Examples 1-3 so as to avoid any cracking of the film, unless the film was obtained through application of a solution diluted in absolute ethanol.

### 5. Film Characterization

The characteristics of the films obtained are detailed in Table 1 which gives the porosity rate of the films, as well as the porosity accounting for micropores (line porosity/micropores) and the pores accounting for mesopores (line porosity/mesopores). The structure of the films was analyzed through a diffraction pattern of X-rays. It was not modified because of the pore forming agent removing step.

TABLE 1

| | Example | | | |
|---|---|---|---|---|
| | 1 (*) | 2 (*) | 3 (*) | C1 |
| CTAB/Si | 0.06 | 0.10 | 0.14 | 0 |
| molar ratio | | | | |
| Structure | Mesopores | Hexagonal 3d | Cubic: | Neither |
| obtained | present: | (spherical | Mesoporous | mesoporosity |
| | No | micelles): | film | nor |
| | structuration | Mesoporous | | structuration: |
| | | film | | Microporous |
| | | | | film |
| Porosity rate | 32% | 55% | 58% | 18% |
| Porosity/ | | 22% | 14.5% | 18% |
| micropores | | | | |
| Porosity/ | | 33% | 43.5% | 0% |
| mesopores | | | (**) | |
| Refractive | 1.33 | 1.25 | | 1.40 |
| index | | | | |

(*) Removal of the pore forming agent through calcination
(**) Estimation

### 6. Evaluation of the Cleanability Properties

### a) Cleanability Test

500 micrograms of synthetic soil were deposited onto the convex surface of an ophthalmic lens provided or not with an antisoiling coating according to the invention, in the form of a soil spot of 20 mm diameter, coming as concentric circles. The synthetic soil (synthetic sebum) used in this test comprised oleic acid as main component.

The lens was then submitted to an automatic wiping effected by a cotton fabric made from the Berkshire company attached to a mechanical robot, under a load of 750 g (perfectly reproducible up and down motion). A wiping motion corresponds to an up or to a down displacement of the cotton fabric. The fabric total travel on the lens is of 40 mm, i.e. 20 mm from one side to the other of a point arranged in the middle of the soil.

The value of the transmission-diffusion rate (haze, abbreviated as H) through the lens is measured with a Hazeguard XL 211 Plus apparatus, after 2, 10, 20, 40, 70, 100, 150 and 200 motions. The indicated value is an average based on three measurements effected on 3 different glasses (1 measurement for each glass).

The diffusion rate H is obtained in accordance with the standard ASTM D1003 “Standard test method for haze and luminous transmittance of transparent plastics”, by measuring simultaneously the total amount of light that is transmitted through a glass (total I) and the amount of diffuse light, through transmission (diffuse I: amount of transmitted light that is deviated with an angle higher than 2.5° as compared to normal direction):

$$H ( \% ) = \frac{diffuse 1}{total 1} \times 100$$

The cleanability test enables especially to determine the number of wiping motions required for obtaining a diffusion rate H lower or equal to 0.5%, which corresponds for a lens to a satisfying clean level.

One may usually observe variations in diffusion depending on conditions of the experiment (temperature, humidity, soil consistency . . . ). In particular, the initial diffusion rates (immediately after soil deposition) may vary significantly from one series of examples to another. The film properties for each series of examples and comparative examples always have been measured from films obtained under the same conditions which makes the results directly comparable to each other.

### b) Results

FIG. 1 enables to compare the performances of the lenses of Examples 2, C1 and of the same substrate only coated with the abrasion-resistant coating based on silanes disclosed in Example 3 of the patent EP 0614957 (example C0).

It could be observed that only a dozen motions enabled to clean the lens of Example 2, a performance that can be compared to that of a commercially available antisoiling coating such as the one derived from the OPTOOL DSX® composition, marketed by Daikin Industries (fluorinated resin comprising perfluoropropylene groups having the formula given in the U.S. Pat. No. 6,183,872), whereas the lenses of Comparative examples C0 (no antisoiling coating, that is to say a lens that has only been coated with the abrasion-resistant and scratch-resistant coating) and C1 (porous coating having an insufficient porosity rate and which pore volume is not sufficiently accessible to oleic acid) are still not under the required threshold (H<0, 5%) after 200 motions.

FIG. 1 demonstrates thus that the accessibility to the porous volume of a porous coating must be sufficient to provide the same with satisfying cleanability properties.

FIG. 2 enables to compare the performances of the lenses of Examples 1, 2 and 3, and reveals that the higher the porosity in the porous coating according to the invention, the faster the lens can be cleaned.

b-1) Case Of Successive Depositions

After the synthetic soil deposition onto the lens of Example 2 (same soil as that described hereabove in the cleanability test), and after the automatic wiping (200 motions) by means of a cotton fabric, a same deposit is applied again onto the same lens. The experiment is repeated several times (for each experiment new soil deposition and use of a clean fabric). FIGS. 3 and 4 show the evolution of the diffusion rate as a function of the number of motions on the lens of Example 2 having been submitted to 1 to 10 successive depositions (3 successive depositions on FIG. 3, 10 successive depositions on FIG. 4).

Even after several depositions, the mesoporous coating of Example 2 remains more efficient as regards cleanability as compared to the coating of Example C1, and therefore to the coating of Example C0 (no antisoiling coating). Cleanability of the coating of Example 2 decreases as a function of the number of depositions. However, after 10 depositions, the system does not change anymore, the coating being probably saturated with soils.

After 3 depositions, the ease of cleaning of the mesoporous coating of Example 2 may be compared to that of the antisoiling coating formed from the commercially available composition OPTOOL DSX®, or to that of coatings that are less efficient than the latter, for example the coating formed from composition KY130® (having the formula as given in the patent JP 2005-187936), marketed by the Shin-Etsu Chemical company.

As opposed to the coating of Example 2, the antisoiling coating formed from the composition OPTOOL DSX®, which structure is not porous, has an unchanged behaviour when repeatedly soiled.

b-2) Regenerating a Porous Coating According to the Invention

As shown on FIG. 5, a porous coating according to the invention, soiled one or many times, may recover its initial properties after having been washed. It is thus somehow “regenerative”. The reflection of the mesoporous coating of Example 2 increases after a synthetic soil deposition (same deposition as in the cleanability test: the soil diffuses light). Wiping the soil using a mechanical robot (100 motions) does not enable to recover the initial reflection level, whereas washing with soap and tap water enables to reduce reflection to a level that is nearly equivalent to the initial one, and additional washing with acetone (15 minutes with ultrasounds) enables to obtain a reflection curve that can be superimposed on the initial reflection curve (prior to being soiled).

The mean reflection coefficient (Rv) values at 380-780 nm are the following ones:

before soil deposition: 0.9%
after soil deposition: 2.9%
after 100 motions: 3.4%
after washing with soap: 1.1%
after additional washing with acetone: 0.9%.

After each reflection measurement, the coating has been dried in an oven at 70° C. for 10 minutes for removing residual water optionally entrapped in the pores.

Several successive regenerations may be effected, without substantially impairing the optical and cleanability properties of the porous coatings according to the invention.

Although the mesoporous coating of Example 2, after washing with soap, is easier to clean than a highly efficient, commercially available antisoiling coating, such as the one obtained from the composition OPTOOL DSX®, it is slightly less cleanable than the same coating that would have never been neither soiled nor washed with soap. This could be explained by the fact that surfactant molecules of the soap solution might remain in mesopores of the coating once the washing has been completed, thus slightly limiting the ease of clean if soiled.

### c) Evaluating the Self-Cleaning Properties

The self-cleaning properties of the coatings according to the invention may be evaluated by measuring the diffusion rate through a lens coated with such a coating just after the deposition of a synthetic soil, as compared with a non self-cleaning coating, and by following the evolution of the diffusion rate over time. The deposition is carried out in the same way as for the cleanability test, without wiping.

FIG. 6 shows that the diffusion rate H of the lens of Example 2 just after deposition of a soil is significantly lower than that of the lenses of Comparative examples C0 and En (C₂-C₈) which, by contrast, are very high (>10%). In addition, as opposed to the two comparative lenses, which do not possess a coating capable of soaking up the soil, the lens of Example 2, provided with the mesoporous coating according to the invention, has a diffusion rate decreasing over time (measurement at t=1 day). This indicates that the cleanliness state of the lens surface is getting better, without requiring any external intervention.

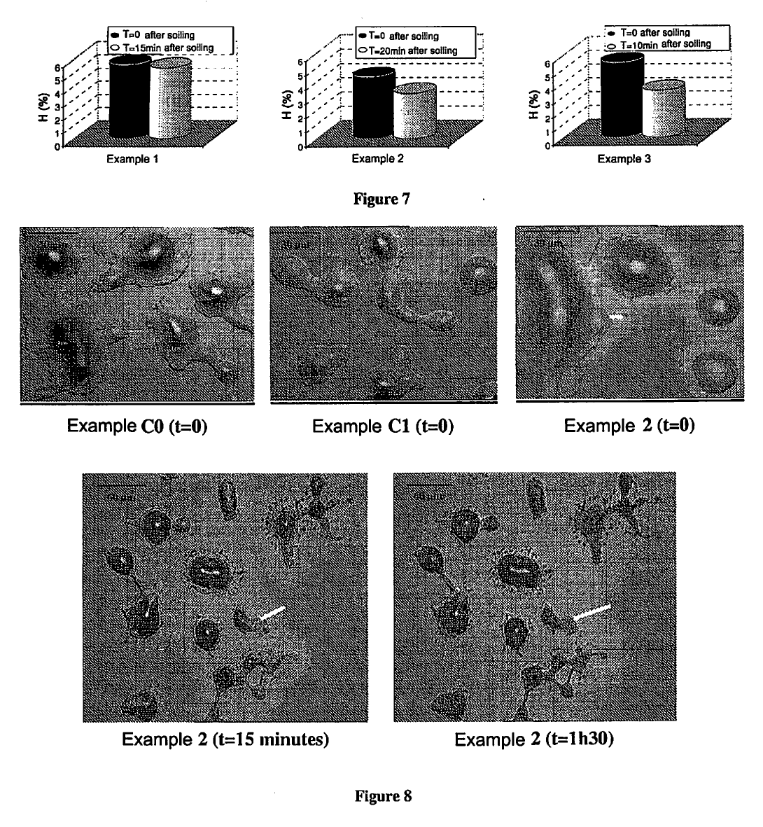

FIG. 7 enables to compare the performances of the lenses of Examples 1, 2 and 3 as regards self-cleaning, and reveals that the more numerous the pores in the porous coating according to the invention, the easier the lens get cleaned. Thus, the diffusion rate H of the lens of Example 3 is 40% lower after 10 minutes than that of the lens of Example 1 after 15 minutes.

c-1) Demonstration of a Change in the Soil Morphology Upon Contacting a Self-Cleaning Coating According to The Invention

FIG. 8 shows the surface condition of the lenses of Examples C0, C1 and 2, immediately after deposition of a synthetic soil (magnified 1000 times). It can be seen on the mesoporous coating of Example 2 a front that is lighter in the vicinity of soil clusters. It is the soil's liquid part which progressively soaks up the porous coating. It is visualized through a white line on the picture.

This front grows over time, as shown on the pictures of FIG. 8 taken respectively 15 minutes and 90 minutes after the soil deposition (magnification×500 for both last pictures), as well as on FIG. 9, which represents the length of this liquid front as a function of time. The soil behaviour in the layers satisfies the Washburn law z²=C×t, wherein z is the length of the impregnation front on a porous surface, t is time, and C=γ×R×cos(θy/2η), θy being the contact angle, R is the pore mean size, γ and η respectively the surface tension and the viscosity of the soil, except in the hereabove formula wherein R should be replaced with the function f(R) bound to the porosity.

Learnings from FIG. 9 coincide with the previously mentioned results: the more numerous the pores in the coating, the higher the impregnation kinetics of the coating, and thus the better the self-cleaning properties.

### D) Porous Coatings with a Silica-Based Matrix that were Made Hydrophobic Through Post-Synthetic Grafting

1. General Procedure for Treating a Porous Film with a Hydrophobic Reactive Compound Bearing at Least One Hydrophobic Group (Post-Synthetic Grafting Carried Out after the Step of Removing the Pore Forming Agent)

The substrate coated with the porous film obtained in paragraph C) 3) hereabove was introduced for 15 minutes into the HMDS-containing ultrasound tank of an Elmasonic apparatus, at room temperature. The ultrasound homogeneity was ensured by setting the apparatus “sweep” function on. The correct procedure of trimethylsilyl group grafting could be followed by an FTIR spectroscopy carried out on the film. FTIR spectra showed a very strong extinction, almost complete, of the silanol groups. Glasses were thereafter rinsed with isopropyl alcohol for removing HMDS excess.

This protocol enabled to prepare the porous films of Examples 4, 5, 6 and C2, which were respectively obtained through HMDS-mediated hydrophobation of the films of Examples 1, 2, 3 and C1. It could be observed that with the coating of Example 2, the porous volume loss resulting from its hydrophobation was of around 25%, i.e. a porosity rate of 41% (example 5). It reached 56% when comparing the coating of Example C1 with that of Example C2. The porosity rate was then of 8% (for a non calcinated film).

2.1 Evaluating the Cleanability Properties with a 300 nm Thickness

The cleanability test was conducted in the same way as hereabove.

FIG. 10 enables to compare the performances as regards the cleanability of the lenses of Examples 1 to 6, and confirms, as to the lenses of Examples 4-6, the tendency which had been already observed for the lenses of Examples 1-3, that is to say the higher the porosity of the porous coating according to the invention, the easier the lens may be cleaned.

The HMDS-mediated hydrophobation of the porous coating was accompanied with a reduction in the lens cleanability. However, when the accessibility to oleic acid and the porosity rate were high enough, such reduction was low. Thus, the cleanability of the lenses of Examples 5 and 6 remained very interesting.

2.2 Evaluating the Cleanability Properties with Various Thicknesses (50-500 nm).

The cleanability test was carried out in the same way as hereabove on ophthalmic lenses coated with coatings having various thicknesses and which characteristics are given in Table 2 hereunder. Examples 10, 11 and Example 2 (corresponding to non post-treated coatings according to the invention) are tested at the same time to visualize the differences between hydrophobic coatings (Examples 5, 7 and 9 post-treated) and non hydrophobic coatings.

TABLE 2

| | Example | | | | | | |
|---|---|---|---|---|---|---|---|
| | 5 | | | | | 2 | C1 |
| | (shown | | | | | (shown | (shown |
| | before) | 7 | 9 | 10 | 11 | before) | before) |
| CTAB/Si | 0.1 | 0.1 | 0.1 | 0.1 | 0.1 | 0.1 | 0 |
| molar ratio | | | | | | | |
| Hydrophobic post- | Yes | Yes | Yes | No | No | No | No |
| treatment (HMDS) | | | | | | | |
| Volume porosity | 41% | 41% | 41% | 55% | 55% | 55% | 18% |
| rate | | | | | | | |
| Coating thickness | 300 | 50 | 500 | 50 | 500 | 300 | 200 |
| (nm) | | | | | | | |

Coatings of Table 2 are all of the mesoporous type except that of Example C1 (microporous type).

FIG. 12 enables to compare the cleanability properties of coatings having various thicknesses.

In all cases, a significant improvement of the cleanability could be observed as compared to a microporous coating. With the 50 nm-thick mesoporous coating of Example 7, made hydrophobic by a HDMS post-treatment, a superior behavior could be observed as compared to a microporous coating reaching the end of a cleaning cycle. It could be noted that the higher the thickness of the porous coating, the better the cleanability of the coating.

Moreover, mesoporous coatings that did not have been made hydrophobic by a post-treatment were significantly more efficient, for a given thickness, than their homologs having been submitted to a hydrophobic post-treatment.

### 3. Evaluating the Self-Cleaning Properties

The self-cleaning properties of the hydrophobic porous coatings according to the invention were evaluated in the same way as for non hydrophobic coatings, by measuring the diffusion rate through a lens coated with such a coating just after deposition of a synthetic soil.

FIG. 11 shows that the diffusion rate H of the lens of Example 4 just after deposition of a soil is only slightly lower than that of the lenses of Comparative examples C0 and C1. Moreover, these results confirm the tendency according to which the higher the porosity rate, the easier the self-cleaning of the lens.

It could be observed that, as opposed to both comparative lenses of Examples C2 (H=4.5, stable over time) and C1 (H=4.3, stable over time), those of Examples 4-6, provided with the porous coating according to the invention, had a diffusion rate decreasing over time (measurement at t=20 minutes), which means that the cleanliness state of the lens surface improves without requiring any external intervention. The diffusion rate through the lens of Example 5 was thus decreased by 11% within 20 minutes and by 19% within 3 hours (transition from H=2.91 to H=2.59 at t=20 minutes and to H=2.37 at t=3 hours). Under the same conditions, the diffusion rate through the lens of Example 2 decreased by 27% within 20 minutes and by 42% within 3 hours (transition from H=2.0 to H=1.45 at t=20 minutes and to H=1.16 at t=3 hours).

Finally, a test was conducted on a glass coated with a mesoporous coating having a thickness of 500 nm instead of 300 nm. The diffusion rate decreased by 20% within 50 minutes instead of 3 hours for a thickness of 300 nm.

The complete hydrophobation through a post-treatment is thus relatively detrimental to the self-cleaning properties, the porous hydrophobic coating being impregnated less rapidly by the soil than the same coating before hydrophobation. Two phenomena could explain this behavior of the hydrophobic porous coating: on the one hand, the lower porous volume thereof, on the other hand the lower affinity of the soil for the surface (due to a hydrophobic surface), less favorable to the spreading of the soil.

### E) Porous Coatings with a Silica-Based Matrix that was Made Hydrophobic by Incorporation of a Hydrophobic Precursor Agent into the Precursor Sol

### 1) Procedures

### 1.1) Precursor Sol Preparation

A CTAB solution in ethanol was prepared, to which non hydrolyzed MTEOS was added. This solution was placed under stirring. The silica sol the preparation of which has been described in paragraph C) 1) hereabove, once cooled down, was added to the MTEOS solution. This step was carried out so that the molar ratios in the end mixture be those indicated in Table 3, then a deposition was effected after 90 minutes stirring.

TABLE 3

| MTEOS content | H₂O/MTEOS | CTAB/Si |
|---|---|---|
| 40% | 3.5 | 0.16 |

### 1.2) Deposition Conditions, Heat Treatment and Removal of the Surfactant by Washing

The mixture was deposited by spin-coating at 3000 rpm for 2 minutes. As opposed to films only based on TEOS, the ambient humidity rate does not play a crucial role, or just a little. Layers obtained did thereafter undergo a heat treatment (110° C. for 12 h) intended to advance the silica network polymerization degree.

CTAB was removed through a soft technology to preserve hydrophobic moieties. Samples were placed for 2×15 min in the acetone-containing tank of an Elmasonic ultrasound delivery system, at room temperature. The structure of the films prepared through such synthesis was a hexagonal 3D structure.

### 2) Evaluating the Self-Cleaning Properties

The self-cleaning properties of the coating according to the invention obtained according to the hereabove protocol (abbreviated example 12) were evaluated by measuring the diffusion rate through a lens coated with such a coating just after the deposition of a synthetic soil, by following the evolution of the diffusion rate over time.

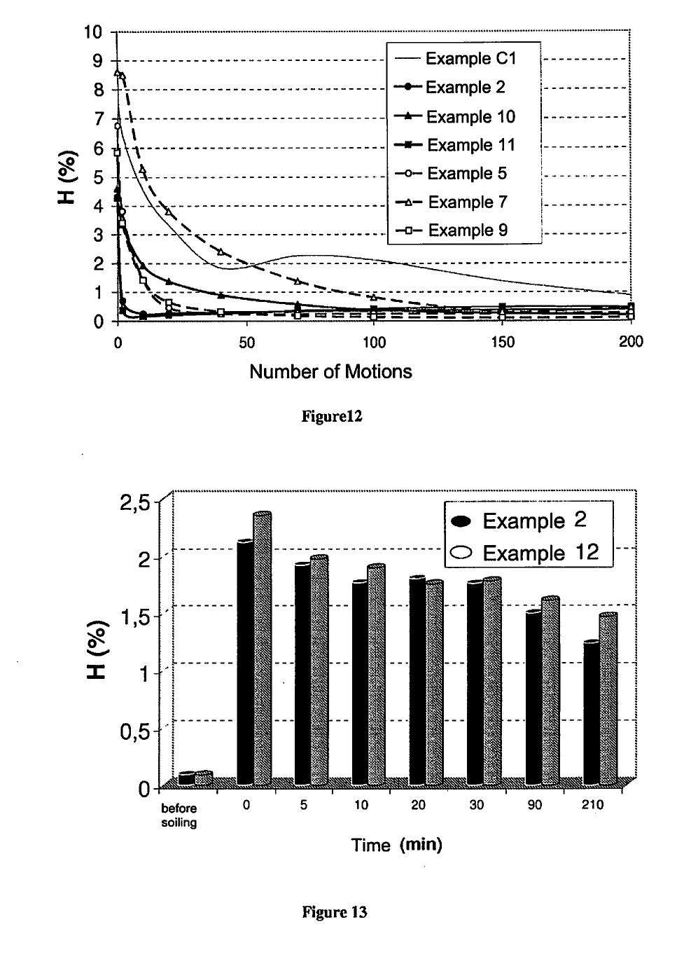

The deposition was carried out in the same way as for the cleanability test, without wiping. FIG. 13 shows the evolution of the diffusion caused by the synthetic soil over time for a mesoporous coating comprising the silica-based matrix made hydrophobic by incorporation into the precursor sol of a hydrophobic precursor agent (MTEOS) such as described hereabove, compared with the mesoporous coating of Example 2 of the invention.

Self-cleaning properties could be observed, that were very similar to those of the coating of Example 2, which demonstrates the outstanding self-cleaning properties of this coating. As opposed to hydrophobation through a post-treatment, the self-cleaning characteristics were very little affected by the incorporation into the precursor sol of a hydrophobic precursor agent.

### F) Oleic Acid Filling Test Protocol to Determine the Potential Volume Filling Ratio of a Porous Coating by Oleic Acid

The substrate carrying the coating for which the potential volume filling ratio has to be measured was first washed in an isopropanol solution at room temperature for 15 minutes, then an oleic acid solution was deposited onto this coating by spin-coating (30 seconds rotation at 2000 rpm, acceleration of around 2000 rpm/s). The procedure was repeated 3 times to be sure the solution did penetrate. The coating was then wiped using a Cemoi cloth to remove the oleic acid in excess and dried in an oven at 70° C. for 10 minutes for removing the water residues possibly entrapped in the pores, then its refractive index was measured.

Determining the Potential Volume Filling Ratio with Oleic Acid of the Porous Coating of Example 2

The volume porosity rate of this coating, measured through IR ellipsometry, was 55%.

The relationship between n_{calculated} refractive index of a porous film having a silica-based matrix and the porosity rate thereof p relies on the nature of the components filling this porosity:

$$ncalculated = ( 1 - p ) \times n s + {{\sum }_{1}}^{n} p ( i ) \times npores ( i )$$

wherein p(i) represents the porosity rate occupied by component i (air, water, oleic acid . . . ), nₚₒᵣₑₛ₍ᵢ₎ represents the refractive index of component i and nₛ represents the refractive index of the matrix (1.488 in the case of a silica matrix). In this formula, the sum of the p(i) corresponds to the porosity rate p.

If the porosity was exclusively occupied by air and oleic acid, this relation would become:

ncalculated=(1−p)×ns+T×p×1.46+(1−T)×p

T representing the filling ratio of the porous volume by oleic acid, 1.46 being the oleic acid refractive index.

For example, if the pores of the coating of Example 2 were totally filled with air (with no water), the calculated refractive index of the coating (devoid of water, initially washed with isopropyl alcohol) would be 1.22 (nₐᵢᵣ=1). If the pores of the coating of Example 2 were totally filled with water, the calculated refractive index of the coating (initially washed with isopropyl alcohol, then filled with water) would be 1.40 (n_{water}=1.33). If the pores of the coating of Example 2 were totally filled with oleic acid, the calculated refractive index of the coating (initially washed with isopropyl alcohol, then hypothetically filled with oleic acid) would be 1.47.

The refractive index measured through ellipsometry of the coating of Example 2 impregnated with oleic acid according to the filling test protocol described hereabove was 1.465. Suppose that the porosity was exclusively occupied by air or oleic acid, it can be inferred from the calculation that the porous volume of this film is occupied by volume for 97% by oleic acid and for 3% by air, i.e. 53.3% of the volume of the film is filled with oleic acid and 1.7% with air. The potential filling ratio of the porous coating volume by oleic acid is thus 53.3% by volume.

It has been confirmed that the reflection spectrum between 380 and 780 nm of the surface of the substrate coated with the porous coating of Example 2 (measurement using the Reflection measurement System (RMS) of a spectrophotometer) superimposed with the simulated spectrum of a coating having a porosity rate of 55% occupied for 97% by oleic acid.

A perfect coincidence could be obtained between the measured optical values (hue angle H, chroma C*, mean reflection Rₘ and reflection in the visible spectrum Rᵥ) and the simulated optical values. The chosen model (occupation of the porosity 100% by air and oleic acid) is thus exact.

To conclude, oleic acid could access almost all of the pores of the coating of Example 2. The potential filling ratio of its porous volume by oleic acid was 97%.

Determining the Potential Volume Filling Ratio with Oleic Acid of the Porous Coating of Example C1

The volume porosity rate of this coating was 18%.

According to the previously used relation, if the pores of the coating of Example C1 were totally filled with air (with no water), the calculated refractive index of the coating (devoid of water, initially washed with isopropyl alcohol) would be 1.40 (nₐᵢᵣ=1).

If the pores of the coating of Example C1 were totally filled with oleic acid, the calculated refractive index of the coating (initially washed with isopropyl alcohol, then hypothetically filled with oleic acid) would be 1.483 (n_{oleic acid}=1.46).

The refractive index measures and the comparison of the measured and simulated spectra made it possible to conclude that oleic acid cannot penetrate into the porous network of the coating of Example C1 (the potential volume filling ratio with oleic acid is nil). The reflection spectrum of the coating was unchanged before and after the filling test.

Determining the Potential Volume Filling Ratio with Oleic Acid of the Porous Coating of Example 5 (Mesoporous Film Graft with HMDS)

The volume porosity rate of this coating was 32% (this value was derived from an ellipsometry measurement of the refractive index, assuming that the film was made of silica and air). The ellipsometry measurement of the refractive index thereof did provide a value of 1.33.

If the pores of the coating of Example 5 were totally filled with oleic acid, the calculated refractive index of the coating (initially washed with isopropyl alcohol, then hypothetically filled with oleic acid) would be 1.479 (n_{oleic acid}=1.46). Since the coating refractive index after the previously described filling test was 1.46, it could be inferred therefrom that the filling ratio of the porous volume by oleic acid was 87.1%. The simulated reflection spectra did coincide with the measured spectra. The potential filling ratio of the porous coating volume by oleic acid was thus 28% by volume.

These results show that a mesoporous film, the matrix of which had been made hydrophobic through HMDS grafting retained characteristics of high accessibility to oleic acid.

Determining the Potential Volume Filling Ratio with Oleic Acid of the Porous Coating of Example C2 (Obtained Through HMDS-Mediated Hydrophobation of C1)

The volume porosity rate of this coating was 8%. The ellipsometry measurement of the refractive index thereof did provide a value of 1.45.

The refractive index measures and the comparison of the measured and simulated spectra made it possible to conclude that oleic acid cannot penetrate into the porous network of the coating of Example C2. Since this coating had a hydrophobic character, water could not be present in the pores thereof to block the access to oleic acid. The insufficient size of the micropores is in all likelihood responsible for the potential volume filling ratio with oleic acid of 0%.

1.-18. (canceled)

19. A method comprising:
obtaining a porous coating having a polysiloxane matrix, wherein the porous coating:
has no photocatalytic properties;
has a porosity rate ranging from 25 to 70% by volume; and
has a volume such that the potential filling ratio of said porous coating volume by oleic acid is at least 25% by volume; and
using the porous coating as an antisoiling coating.

20. The method of claim 19, wherein the porous coating is further defined as a mesoporous coating with mesopores have a size ranging from 2 to 50 nm.

21. The method of claim 19, wherein the polysiloxane matrix is obtained from a composition comprising a precursor containing at least one silicon atom bound to 4 hydrolyzable or hydroxyl groups.

22. The method of claim 19, wherein the polysiloxane matrix is prepared from at least one inorganic precursor agent of formula:
Si(X)₄ (I)
wherein the X groups independently represent hydrolyzable groups or a hydrolyzate of this precursor agent.

23. The method of claim 22, wherein the X groups are independently an —O—R alkoxy or —O—C(O)R acyloxy group, where R is an alkyl group, Cl, Br, or I.

24. The method of claim 23, wherein the X groups are independently an —O—R alkoxy or —O—C(O)R acyloxy group, where R is a C₁-C₆ alkyl group, Cl, Br or I.

25. The method of claim 19, wherein the polysiloxane matrix has not been treated with a hydrophobic reactive compound bearing at least one hydrophobic group.

26. The method of claim 19, wherein the polysiloxane matrix has been prepared from a sol not containing any hydrophobic precursor agent bearing at least one hydrophobic group.

27. The method of claim 19, wherein the polysiloxane matrix is hydrophobic.

28. The method of claim 27, wherein the polysiloxane matrix comprises silanol groups having been derivatized to hydrophobic groups through reaction with a hydrophobic reactive compound bearing at least one hydrophobic group.

29. The method of claim 27, wherein the polysiloxane matrix has been prepared from a sol comprising a hydrophobic precursor agent bearing at least one hydrophobic group.

30. The method of claim 19, wherein using the porous coating as an antisoiling coating comprises depositing the porous coating at least part of a main surface of a substrate made of organic or inorganic glass.

31. The method of claim 19, further comprising depositing the porous coating onto at least part of the main surface of a bare substrate or a substrate that has been coated with one or more functional coating(s) selected from an impact-resistant primer coating, an abrasion-resistant and/or a scratch-resistant coating or a monolayered or multilayered anti-reflection coating.

32. The method of claim 31, wherein the substrate is coated with a stack of one or more layer(s), with the porous coating forming the outer layer.

33. The method of claim 31, wherein the substrate is an optical lens substrate or an optical lens blank substrate.

34. The method of claim 33, wherein the optical lens substrate or the optical lens blank substrate is further defined as an ophthalmic lens substrate or an ophthalmic lens blank substrate.

35. The method of claim 19, wherein the porous coating has a thickness ranging from 50 nm to 5 μm.

36. The method of claim 19, wherein the potential filling ratio of said porous coating volume by oleic acid is at least 30% by volume.

37. The method of claim 19, wherein the antisoiling coating is a self-cleaning coating and/or an easy-to-clean coating.

38. The method of claim 19, wherein the porous coating is used against sebum.

39. The method of claim 19, comprising depositing soil on the porous coating and washing the coating with a surfactant and/or an organic solvent before using the porous coating as an antisoiling coating.
